(19) United States
(12) Patent Application Publication
(10) Pub. No.: US 2026/0142816 A1
(43) Pub. Date: May 21, 2026

(54) CONSTRAINT-DRIVEN TRUST STATE ORCHESTRATION SYSTEM FOR DISTRIBUTED DECISION NETWORKS

(71) Applicant: George William Bickerstaff, III, Greenwich, CT (US)

(72) Inventor: George William Bickerstaff, III, Greenwich, CT (US)

(21) Appl. No.: 19/445,699

(22) Filed: Jan. 12, 2026

(51) Int. Cl. H04L 9/32; H04L 9/00

(52) U.S. Cl. CPC H04L 9/3213; H04L 9/3297; H04L 9/50

(57) ABSTRACT

A constraint-driven trust state orchestration system intercepts proposed actions at execution boundaries prior to execution, deterministically evaluates trust states against constraints, enforces execution exclusively based on cryptographically verifiable qualification outcomes, and immutably records all decisions and outcomes to ensure consistency, auditability, reduced rollback costs, and improved system integrity across distributed decision networks.

### TECHNICAL FIELD

The present invention relates to distributed computing and control systems and, more particularly, to technical systems and methods for enforcing deterministic, constraint-driven trust state qualification and orchestration of actions across distributed decision networks prior to execution.

### BACKGROUND

Distributed computing environments increasingly execute automated decisions across multiple independent services, organizations, and technical domains, where individual systems operate with partial state awareness and autonomous execution authority.

Such automated decisions frequently initiate irreversible operations including financial transfers, access grants, workflow transitions, data writes, and allocation of computational or physical resources across heterogeneous systems.

Conventional approaches validate permissions, compliance rules, or governance conditions after execution or within isolated subsystems, resulting in inconsistent system states, partial execution failures, expensive rollbacks, increased latency, and regulatory exposure.

These shortcomings arise from the absence of a deterministic, system-level mechanism that qualifies trust and eligibility at execution boundaries before irreversible actions occur and enforces those determinations consistently across distributed orchestration layers.

Accordingly, there exists a need for a technical solution that intercepts proposed actions prior to execution, evaluates trust states against deterministic constraints, enforces execution exclusively based on those evaluations, and immutably records the resulting decisions to ensure consistency, auditability, and system integrity.

### SUMMARY OF THE INVENTION

The disclosed invention provides a constraint-driven trust state orchestration system that intercepts proposed actions at defined execution boundaries prior to database commits, resource allocation, or inter-system message dispatch.

A trust state engine generates a deterministic trust state object representing eligibility, contextual validity, and risk posture for a proposed action at a specific point in time, based on verified attestations and execution context.

A decision qualification gateway evaluates the trust state against deterministically compiled constraints, generates a cryptographically verifiable qualification outcome token, and enforces execution exclusively based on that token.

An orchestration engine coordinates execution, suspension, modification, or termination of actions across distributed systems, ensuring that no irreversible operation occurs without a valid qualification outcome token.

All trust states, constraint inputs, evaluation artifacts, qualification outcomes, and orchestration decisions are immutably recorded in an append-only audit ledger, enabling verification, replay, and regulatory evidence generation while reducing rollback costs and preventing invalid intermediate system states.

### BRIEF DESCRIPTION OF THE DRAWINGS

FIG. 1 (TRUST STATE ORCHESTRATION SYSTEM ARCHITECTURE) is a block diagram illustrating an example system architecture for constraint-driven trust state orchestration across distributed decision networks.

FIG. 2 (TRUST STATE AND CONSTRAINT EVALUATION FLOW) is a flow diagram illustrating an example process for trust state generation and deterministic constraint evaluation prior to execution of a proposed action.

FIG. 3 (PRE-EXECUTION DECISION QUALIFICATION AND ENFORCEMENT) is a block and flow diagram illustrating pre-execution decision qualification and enforcement at one or more execution boundaries.

FIG. 4 (IMMUTABLE AUDIT LEDGER AND VERIFICATION SYSTEM) is a block diagram illustrating an example immutable audit ledger and verification system for recording and validating trust state evaluations and orchestration outcomes.

FIG. 5 (DISTRIBUTED ORCHESTRATION ENFORCEMENT) is a block diagram illustrating distributed orchestration enforcement across heterogeneous computing systems and organizational domains.

### DETAILED DESCRIPTION

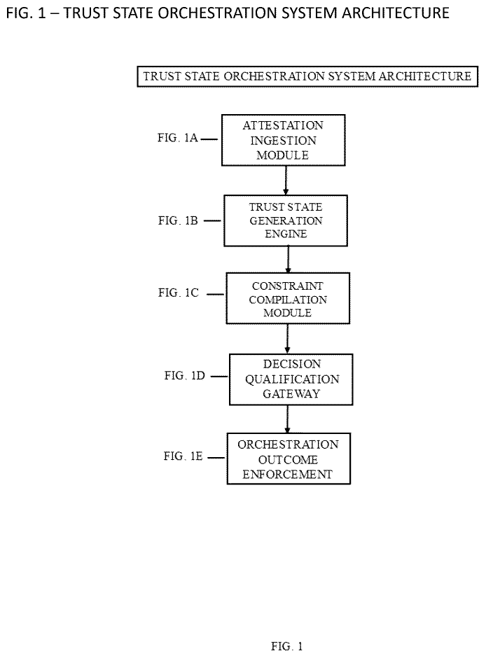

### FIG. 1—System Architecture

FIG. 1 illustrates a trust state orchestration system in which proposed actions are intercepted at execution boundaries and routed through deterministic trust qualification prior to execution. The system integrates a trust state engine, decision qualification gateway, orchestration engine, and audit ledger. This architecture prevents irreversible actions from occurring without validated authorization.

FIG. 1A illustrates attestation ingestion in which identity credentials, authorization signals, compliance attestations, and execution context metadata are collected from distributed sources. Inputs are normalized into a consistent data model. This normalization ensures deterministic evaluation across heterogeneous systems.

FIG. 1B illustrates trust state generation in which the trust state engine compiles attestations into a time-bound trust state object. The trust state object encodes eligibility, risk posture, and contextual validity. Versioning enables replay and auditability.

FIG. 1C illustrates constraint compilation in which applicable constraints are selected based on action type and execution context. Constraints are compiled into a deterministic evaluation format. This compilation ensures repeatable evaluation outcomes.

FIG. 1D illustrates decision qualification where the trust state is evaluated against compiled constraints at the execution boundary. A qualification outcome token is generated that cryptographically binds inputs and results. Execution is blocked until a valid token is presented.

FIG. 1E illustrates orchestration outcome enforcement in which the orchestration engine permits, modifies, or blocks execution solely based on the qualification outcome token. Unauthorized execution paths are prevented system-wide. Partial execution states are eliminated.

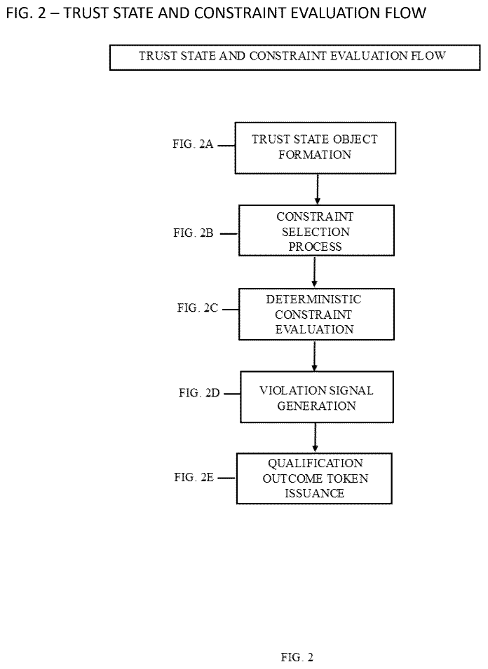

### FIG. 2—Trust State and Constraint Evaluation

FIG. 2 illustrates the lifecycle of trust state creation and deterministic constraint evaluation prior to execution. Identical inputs produce identical outcomes. Trust state transitions are explicitly recorded.

FIG. 2A illustrates trust state object formation including identity attributes, contextual metadata, execution scope, and temporal markers. The object structure supports consistent evaluation across distributed systems. Historical comparison is enabled.

FIG. 2B illustrates constraint selection based on action type, system role, and execution context. Only relevant constraints are selected for evaluation. This reduces computational overhead and ambiguity.

FIG. 2C illustrates deterministic constraint evaluation producing binary or multi-state outcomes. Evaluation logic is consistent across executions. Results are traceable to specific inputs.

FIG. 2D illustrates violation signal generation when one or more constraints are not satisfied. Violation signals include structured metadata describing failure conditions. These signals prevent execution and trigger remediation workflows.

FIG. 2E illustrates qualification outcome token issuance binding evaluation inputs and outcomes. The token is cryptographically verifiable and time-bound. Orchestration proceeds only with a valid token.

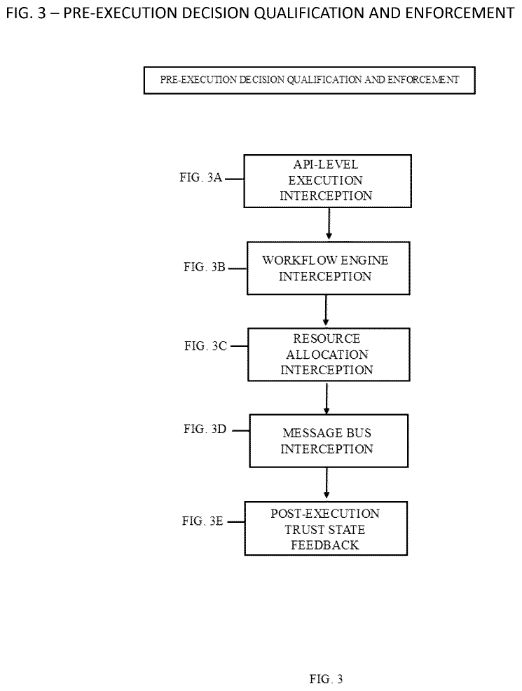

### FIG. 3—Decision Qualification and Enforcement

FIG. 3 illustrates pre-execution enforcement mechanisms integrated at execution boundaries. Interception occurs before irreversible operations. Enforcement is centralized while remaining scalable.

FIG. 3A illustrates API-level interception before request processing. Requests lacking valid qualification tokens are rejected. Unauthorized execution is prevented.

FIG. 3B illustrates workflow engine interception before task execution. Tasks are suspended until qualification is confirmed. System consistency is preserved.

FIG. 3C illustrates resource allocation interception prior to provisioning. Resources are allocated only after approval. Rollback costs and latency are reduced.

FIG. 3D illustrates message bus interception preventing unauthorized inter-system communication. Messages lacking authorization are blocked. Distributed state integrity is maintained.

FIG. 3E illustrates post-execution trust state feedback incorporating execution outcomes. Feedback updates future evaluations. Adaptive governance is enabled.

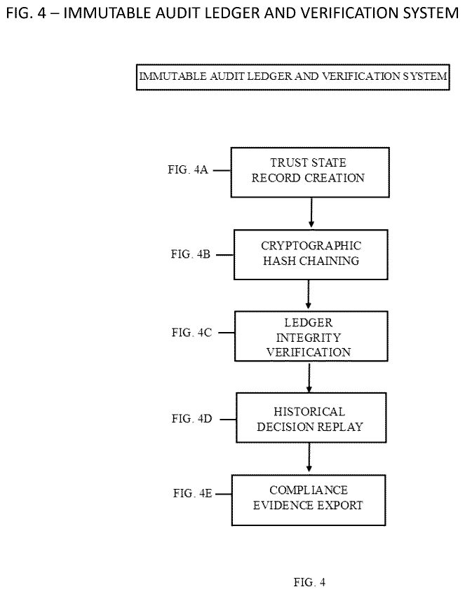

### FIG. 4—Audit Ledger and Verification

FIG. 4 illustrates immutable audit ledger recording and verification. The ledger provides tamper-resistant evidence of trust decisions. Regulatory compliance is supported.

FIG. 4A illustrates structured record creation for trust state evaluations including inputs, constraints, outcomes, and timestamps. Records are ordered deterministically. This supports replay.

FIG. 4B illustrates cryptographic hash chaining of ledger entries. Each record references a prior record. Integrity and immutability are ensured.

FIG. 4C illustrates ledger integrity verification detecting unauthorized modification. Verification may be performed independently. Trustworthiness is preserved.

FIG. 4D illustrates historical decision replay using stored records. Replay enables forensic analysis. Outcomes are independently verifiable.

FIG. 4E illustrates compliance evidence export transforming records into standardized evidence packages. Reporting is automated. Audit friction is reduced.

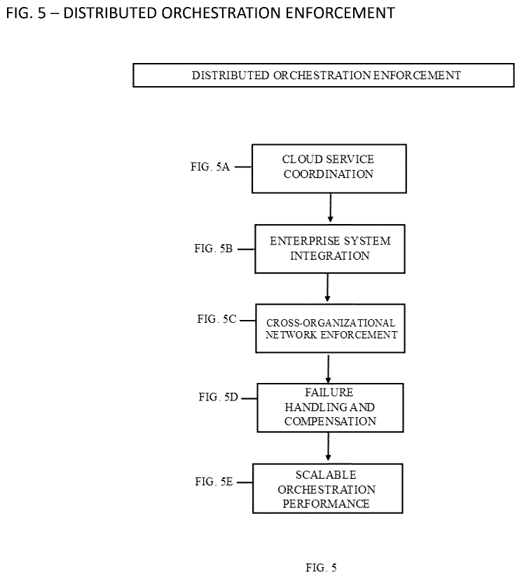

### FIG. 5—Distributed Orchestration

FIG. 5 illustrates orchestration enforcement across heterogeneous and cross-organizational systems. Enforcement logic remains consistent across domains. System integrity is preserved.

FIG. 5A illustrates coordination across cloud services. Execution occurs only after qualification. Provider consistency is maintained.

FIG. 5B illustrates coordination across enterprise systems. Legacy systems enforce trust states via adapters. Refactoring is avoided.

FIG. 5C illustrates coordination across partner and cross-organizational networks. External systems consume qualification outcome tokens. Trust is externally verifiable.

FIG. 5D illustrates failure handling and compensation workflows. Invalid actions are halted cleanly. No partial state persists.

FIG. 5E illustrates scalable orchestration under increasing transaction volume. Evaluation and enforcement scale independently. Deterministic performance is maintained.

1. A system for enforcing constraint-driven trust state orchestration, comprising: a trust state engine configured to generate a deterministic trust state object for a proposed action; a decision qualification gateway configured to intercept the proposed action at an execution boundary prior to execution; a constraint evaluation module configured to deterministically evaluate the trust state against one or more constraints and generate a cryptographically verifiable qualification outcome token; an orchestration engine configured to permit, modify, or block execution solely based on the qualification outcome token; and an audit ledger configured to immutably record trust states, constraint inputs, evaluation artifacts, qualification outcomes, and orchestration decisions.

2. A method comprising intercepting a proposed action at an execution boundary prior to execution; generating a deterministic trust state for the proposed action; evaluating the trust state against compiled constraints; generating a cryptographically verifiable qualification outcome token; enforcing execution exclusively based on the qualification outcome token; and immutably recording the evaluation and enforcement.

3. A non-transitory computer-readable medium storing instructions that, when executed, cause a system to perform the method of claim 2. Dependent Claims

4. The system of claim 1, wherein the execution boundary occurs prior to database commit.

5. The system of claim 1, wherein the execution boundary occurs prior to resource allocation.

6. The system of claim 1, wherein the qualification outcome token is time-bound and cryptographically verifiable.

7. The system of claim 1, wherein constraint evaluation produces identical outcomes for identical inputs.

8. The system of claim 1, wherein the audit ledger is append-only and cryptographically hash chained.

9. The method of claim 2, further comprising generating violation signals upon constraint failure.

10. The system of claim 1, wherein orchestration is enforced across multiple independent organizations or administrative domains.
